(19) United States
(12) Patent Application Publication
(10) Pub. No.: US 2025/0165882 A1
(43) Pub. Date: May 22, 2025

(54) TICKET ENGINE SYSTEM AND METHOD

(71) Applicant: DeLorean Artificial Intelligence, Inc., Palm Beach, FL (US)

(72) Inventors: Severence M. MacLaughlin, Palm Beach, FL (US); Ram Prasad Bora, Palm Beach, FL (US); Dhiraj Sharma, Palm Beach, FL (US)

(21) Appl. No.: 18/513,025

(22) Filed: Nov. 17, 2023

(51) Int. Cl. G06Q 10/0631; G06F 40/295; G06Q 10/0639

(52) U.S. Cl. CPC G06Q 10/063112; G06F 40/295; G06Q 10/06398

(57) ABSTRACT

Techniques for managing work tickets, including receiving a work ticket including a textual description of a technical issue to be resolved, determining, based on the textual description, ticket data including an issue description indicative of the technical issue to be resolved, determining, based on application of the issue description to a group mapping model, an agent group corresponding to the technical issue, determining, based on application of the agent group to an agent mapping model, an agent of the group for resolving the technical issue, and providing, in response to determining the agent of the group for resolving the technical issue, the work ticket to the agent.

### FIELD

Embodiments relate generally to completion of work tickets and more particularly to systems and methods for assessing, routing, implementing and monitoring work tickets.

### BACKGROUND

Companies often provide computer-based access and services to various entities, such as customers and employees. In many instances, computer-based access and services employ a variety of software applications, networking facilities, and computing technologies (collectively known as “computing infrastructure” or “CI”). The multitude of sophisticated software, hardware, and communication subsystems that constitute the CIs are often complex, difficult to use, malfunction, or otherwise create technical issues for users. In many instances, a technical support organization (“TSO”), sometime referred to as a “tech support” or “IT support,” is provided to help users resolve technical issues, such as issues with hardware, software, or electronic devices. Technical support agents of a TSO are typically trained and possess expertise in the products or services they support, and often have access to extensive knowledge bases and resources to aid in issue resolution. A TSO often operates to receive user requests for assistance with issues and to route the request to agents that can assist in resolving the issues.

### SUMMARY

Technical support organizations (“TSOs”) are typically tasked with providing a positive resolution in a minimal amount of time. In an effort to provide prompt and positive resolutions, TSOs employ agents that specialize in resolving the types of issues faced by users. For example, where a computing infrastructure (“CI”) employs four different software applications, a TSO may include, for each of the software applications, a respective group (or “team”) of agents that are experts on that software application. Accordingly, it can be desirable for a TSO to route requests concerning issues in a given area to an agent that is an expert in that area. Continuing with the above example, it would be desirable for a user request concerning a first software application of the software applications to be routed to an agent in the group designated as an expert for the first software application.

Although existing systems often have procedures in place that attempt to route requests to qualified agents, they often fail to identify a suitable agent or group and, as a result, can increase the amount of time it takes to reach a positive resolution or inhibit reaching a satisfactory resolution all together. For example, a TSO may employ a dispatcher that is tasked with receiving user requests for assistance with an issue, identifying a suitable agent for resolving the issue, and assigning a corresponding ticket to the identified agent. Ideally, the agent assigned to the ticket is qualified to handle the issue and, as such, can resolve the issue in a prompt manner. Unfortunately, identifying a suitable agent is not an easy task and can often result in routing of a ticket to an agent that is not highly qualified to handle the issue, routing of a ticket to an agent that lacks availability to promptly address the issue, or the like. In the case of an agent that is not highly qualified (or is unqualified), the agent may recognize this and route the ticket back to the dispatcher or to another agent. In the case of the agent lacking availability to promptly address the issue (e.g., where the agent is overwhelmed with a number of other tickets), it may be a relatively long time before the agent can address the issue, or the agent may recognize the situation and route the ticket back to the dispatcher (or to another agent). This can create delays in resolving an issue or cause routing of an issue to a lesser qualified agent, which can lead to slower and lower quality resolutions. Moreover, agents may become overwhelmed with ticket assignments or be assigned to tasks on which they are not experts, which can reduce agent morale, and the overall level of service provided by agents.

Provided are embodiments for assessing, routing, implementing and monitoring work tickets, such as work tickets of a TSO. In some embodiments, a ticketing engine is operable to assess, route, and monitor work tickets. For example, a ticketing engine may receive work tickets associated with a technical issue to be resolved, determine an agent group or agent to which the work tickets are to be assigned, route the work tickets to the determined agent groups or agents, and monitor for data concerning resolution of the work tickets and performance by the agent groups or agents.

In some embodiments, a ticketing engine employs a ticket assignment module that is operable to assign tickets to qualified agents. For example, the ticketing engine may employ a ticket assignment module that is operable to receive a user-initiated work ticket concerning a given issue, identify an agent group for resolving the issue (e.g., based on content of the work ticket and historical performance of the group), identify an agent within the group for resolving the issue (e.g., based on historical performance of the agent and current agent availability), and assign the work ticket to the agent.

In some embodiments, the ticket assignment module employs artificial intelligence (AI) based modeling for identifying agent assignments. For example, the ticket assignment module may employ a group mapping model to identify an agent group for resolving an issue and employ an agent mapping model to identify a particular agent of the agent group for resolving the issue. In some embodiments, the group mapping model is machine learning model trained using a ticketing training dataset that includes historical ticket data, such as ticket assignment logs (e.g., logs of past work tickets, their attributes, and their respective assignments to groups or agents). In some embodiments, the agent mapping model is a machine learning model trained using a ticketing training dataset that includes historical ticket data, such as agent performance logs (e.g., logs of agent performance data for past ticket assignments). Although embodiments are described in the context of machine learning (and certain types of machined learning techniques), embodiments may employ a suitable form of AI modeling, or other modeling techniques.

In some embodiments, the ticketing engine employs a performance module that is operable to monitor progress of work tickets and performance of agents or agent groups. For example, the ticketing engine may employ a performance module that is operable to assemble ticket performance data that is indicative of various aspects of work ticket resolutions, such as associated issues, assigned agent groups, assigned agents, whether resolutions were reached, amounts of time to reach resolutions, quality scoring for the resolutions, or the like. The performance data may, for example, be used to update a ticket assignment log or an agent performance log, which may, in turn, be used to train the ticketing models.

In some embodiments, the ticketing engine employs a training module that is operable to train one or more ticketing modules. For example, the ticketing engine may employ a training module that is operable to train the group mapping model using a ticketing training dataset that includes historical ticket data, such as a ticket assignment log, or to train an agent mapping model using a ticketing training dataset that includes historical agent data, such as an agent performance log. In some embodiments, the training module may include a verification process to ascertain the effectiveness of the ticketing engine's recommendations. Specifically, this could involve a review procedure to check if a particular work ticket has been correctly allocated to the agent suggested by the ticketing engine. This review process may serve a dual purpose. Firstly, it may allow the training module to automatically incorporate this feedback, thereby enhancing its ability to make more accurate recommendations in the future. Secondly, it may provide an opportunity for human oversight, where another entity, such as a human reviewer, can manually assess the outcomes and adjust the system's parameters accordingly. This intervention can, for example, help fine-tune the ticketing engine's performance, ensuring it aligns more closely with operational requirements and improves its recommendation process over time.

### BRIEF DESCRIPTION OF THE DRAWINGS

FIG. 1A is diagram that illustrates technical support environment in accordance with one or more embodiments.

FIG. 1B is diagram that illustrates operational aspects of a technical support organization environment in accordance with one or more embodiments.

FIG. 2 is a diagram that illustrates example ticket data attributes in accordance with one or more embodiments.

FIGS. 3A and 3B are diagrams that illustrate example ticket data in accordance with one or more embodiments.

FIG. 4 is a diagram that illustrates an example agent performance log in accordance with one or more embodiments.

FIG. 5 is a flowchart diagram that illustrates a method of assigning work tickets in accordance with one or more embodiments.

FIG. 6 is a flowchart diagram that illustrates a method of training ticketing models in accordance with one or more embodiments.

FIG. 7 is a flowchart diagram that illustrates a method of monitoring work tickets in accordance with one or more embodiments.

FIGS. 8A-8F are diagrams that illustrate example reporting in accordance with one or more embodiments.

FIG. 9 is a diagram that illustrates an example computer system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Provided in some embodiments are techniques for assessing, routing, implementing and monitoring work tickets, such as work tickets of a technical support organizations (“TSO”). In some embodiments, a ticketing engine is operable to assess, route, and monitor work tickets. For example, a ticketing engine may receive work tickets associated with a technical issue to be resolved, determine an agent group or agent to which the work tickets are to be assigned, route the work tickets to the determined agent groups or agents, and monitor for data concerning resolution of the work tickets and performance by the agent groups or agents.

In some embodiments, a ticketing engine employs a ticket assignment module that is operable to assign tickets to qualified agents. For example, the ticketing engine may employ a ticket assignment module that is operable to receive a user-initiated work ticket concerning a given issue, identify an agent group for resolving the issue (e.g., based on content of the work ticket and historical performance of the group), identify an agent within the group for resolving the issue (e.g., based on historical performance of the agent and current agent availability), and assign the work ticket to the agent.

In some embodiments, the ticket assignment module employs artificial intelligence (AI) based modeling for identifying agent assignments. For example, the ticket assignment module may employ a group mapping model to identify an agent group for resolving an issue and employ an agent mapping model to identify a particular agent of the agent group for resolving the issue. In some embodiments, the group mapping model is machine learning model trained using a ticketing training dataset that includes historical ticket data, such as ticket assignment logs (e.g., logs of past work tickets, their attributes, and their respective assignments to groups or agents). In some embodiments, the agent mapping model is a machine learning model trained using a ticketing training dataset that includes historical ticket data, such as agent performance logs (e.g., logs of agent performance data for past ticket assignments).

In some embodiments, the ticketing engine employs a performance module that is operable to monitor progress of work tickets and performance of agents or agent groups. For example, the ticketing engine may employ a performance module that is operable to assemble ticket performance data that is indicative of various aspects of work ticket resolutions, such as associated issues, assigned agent groups, assigned agents, whether resolutions were reached, amounts of time to reach resolutions, quality scoring for the resolutions, or the like. The performance data may, for example, be used to update a ticket assignment log or an agent performance log, which may, in turn, be used to train the ticketing models.

In some embodiments, the ticketing engine employs a training module that is operable to train one or more ticketing modules. For example, the ticketing engine may employ a training module that is operable to train the group mapping model using a ticketing training dataset that includes historical ticket data, such as a ticket assignment log, or to train an agent mapping model using a ticketing training dataset that includes historical agent data, such as an agent performance log. In some embodiments, the training module may include a verification process to ascertain the effectiveness of the ticketing engine's recommendations. Specifically, this could involve a review procedure to check if a particular work ticket has been correctly allocated to the agent suggested by the ticketing engine. This review process may serve a dual purpose. Firstly, it may allow the training module to automatically incorporate this feedback, thereby enhancing its ability to make more accurate recommendations in the future. Secondly, it may provide an opportunity for human oversight, where another entity, such as a human reviewer, can manually assess the outcomes and adjust the system's parameters accordingly. This intervention can, for example, help fine-tune the ticketing engine's performance, ensuring it aligns more closely with operational requirements and improves its recommendation process over time.

Although certain example embodiments are described in the context of TSOs and computing infrastructure (“CI”), embodiments may be employed in any suitable context, such as information technology help desks, customer support centers, telecommunications support services, managed service providers (“MSPs”), cybersecurity incident response teams, public safety telecommunicator systems, or the like. Furthermore, although certain example embodiments are described in the context of English text, embodiments may be employed for any suitable language, such as ingesting, processing, and outputting text in Spanish, Italian, Portuguese, etc.

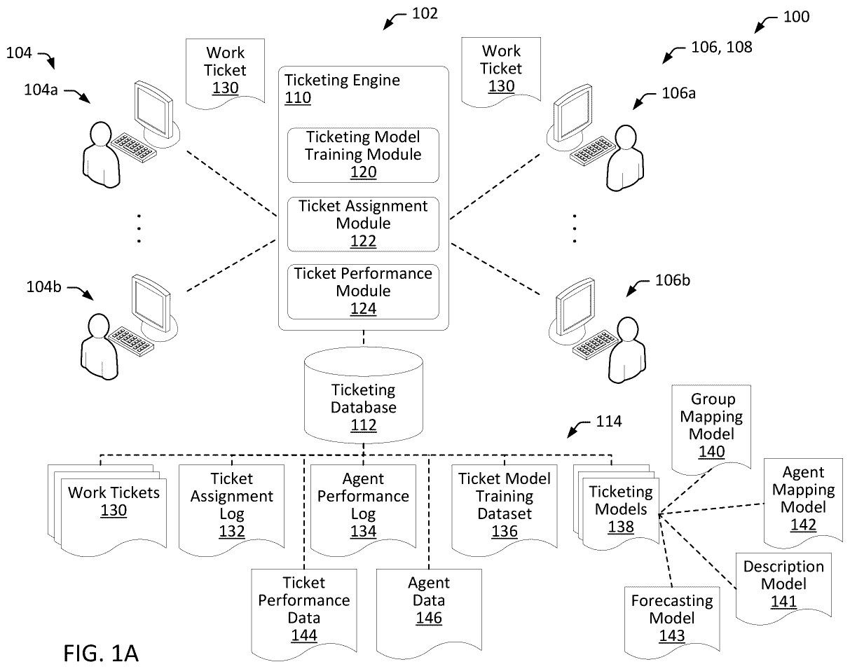

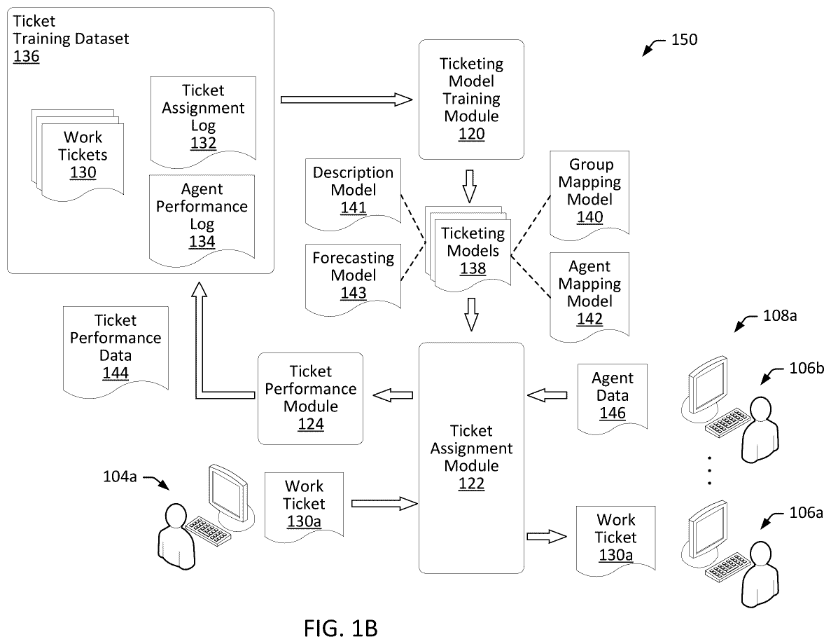

FIG. 1A is a diagram that illustrates a technical support environment 100 in accordance with one or more embodiments. In the illustrated embodiment, the technical support environment 100 includes a work ticket management system (“management system”) 102, users 104 (e.g., including users 104a and 104b), agents 106 (e.g., including agents 106a and 106b), which may be part of one or more agent groups 108 (e.g., a software IT agent group, a hardware IT agent group, a device IT agent group, or the like). The management system 102 includes a ticketing engine 110 and ticketing database 112 storing associated ticketing data 114. The ticketing engine 110 may include a ticketing model training module (“training module”) 120, a ticket assignment module (“assignment module”) 122, and a ticket performance module (“performance module”) 124. The ticketing data 114 may include, for example, work tickets 130, a ticket assignment log 132, a ticket performance log 134, a ticket model training dataset 136, one or more ticketing models 138 (e.g., including one or more group mapping models 140, one or more agent mapping models 142, one or more description models 141, and one or more forecasting models 143), ticket performance data 144, and agent data 146.

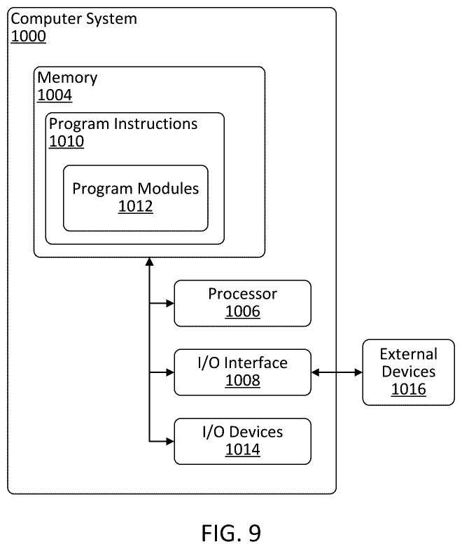

In some embodiments, the management system 102 includes a computer system that is the same or similar to that of computer system 1000 described with regard to at least FIG. 9. In some embodiments, the ticketing engine 110 is executed by the management system 102 to perform operations described here, such as assessing, routing, or monitoring work tickets 130. For example, the ticketing engine 110 may be a software application that is executed on the management system 102 to assess content of work tickets 130, to assign work tickets 130 to agents 106 based on the assessment of the content of the work tickets 130, and to monitor and record progress of handling of the work tickets 130 by agents 106.

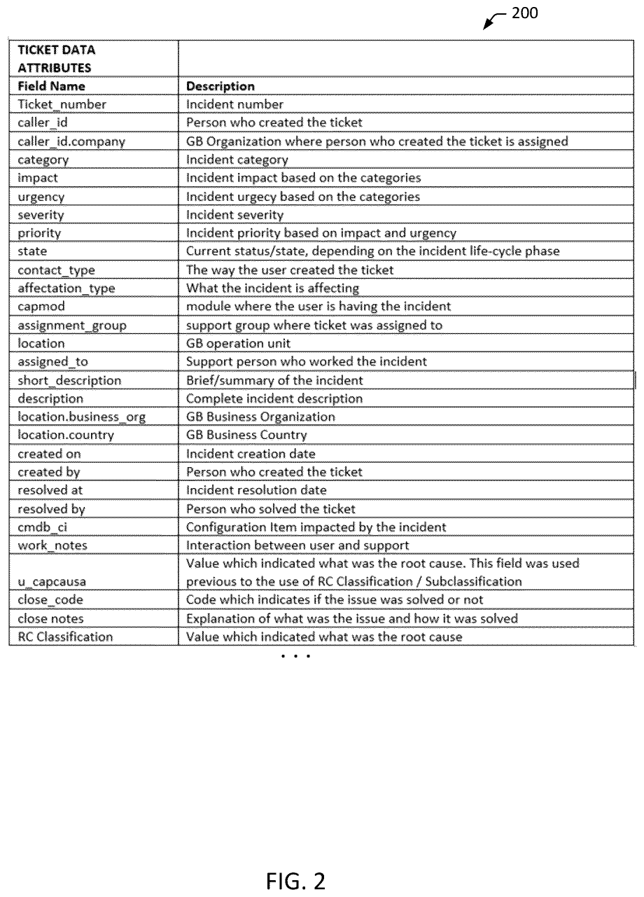

A work ticket 130 may include a request for assistance with an issue. For example, in the context of a TSO for a CI system employing hardware, software, or electronic devices, a work ticket 130 may include a document outlining a request for assistance with an issue involving the hardware, software, or electronic devices of the CI. A work ticket 130 may, for example, include work ticket data (or “ticket data”), such as populated attribute values for corresponding attribute fields, such as a ticket number, a caller identification, a “full” description of the associated issue, a “short” description of the associated issue, or the like. In some embodiments, the attribute values are populated or otherwise provided by a user 104. FIG. 2 is a diagram that illustrates example ticket data attributes 200 in accordance with one or more embodiments. In the illustrated embodiment, the example ticket data attributes 200 include attributes of “Ticket_number”, “caller id” and so forth, accompanied by an associated description of what the attribute concerns. For example, the “Ticket_number” attribute may be an “incident number” associated with the work ticket. The “description” attribute may be a “complete incident description” associated with the work ticket. The “short_description” attribute may be a “brief/summary of the incident” associated with the work ticket (e.g., the short description may be an abbreviated version of the “complete incident description” of the “description” or one or more other attribute values). As described, in some embodiments, the short description for a work ticket 130 may be provided by a user or generated based on content of the work ticket 130. For example, a short description attribute value may be generated by a large language model (LLM) based on attribute values of the work ticket, such as the “description” attribute value or one or more other attribute values. In some embodiments, the LLM employed may be a relatively large LLM, such as Bidirectional Encoder Representations from Transformers (BERT) or the like, or an abbreviated LLM, such as DistilBERT or the like. BERT may employ a transformer-based neural network model, employing a bidirectional approach to consider context from both left and right sides of a sentence, which may provide benefits for sentiment analysis, named entity recognition, and question answering. BERT may employ three modules, including an embedding module (e.g., a module that converts an array of one-hot encoded tokens into an array of vectors representing the tokens), a stack of encoders module (e.g., Transformer encoders that perform transformations over the array of representation vectors), and un-embedding module (e.g., a module that converts the final representation vectors into one-hot encoded tokens again). The un-embedding module may be used for pretraining, but may not be employed for downstream tasks (e.g., the representation vectors output at the end of the stack of encoders may be as a vector representation of the text input, and train a smaller model on top of that). DistilBERT may employ a relatively smaller version of the BERT model, including use of a reduced number of training parameters to reduce the overall size of the model, which may improve computational efficiency and be suitable for resource-constrained environments.

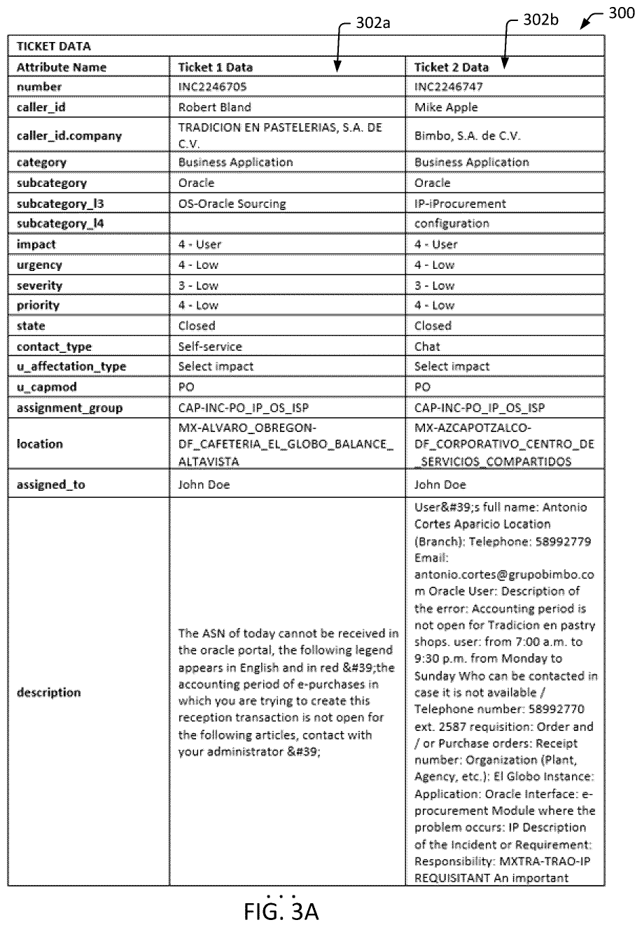

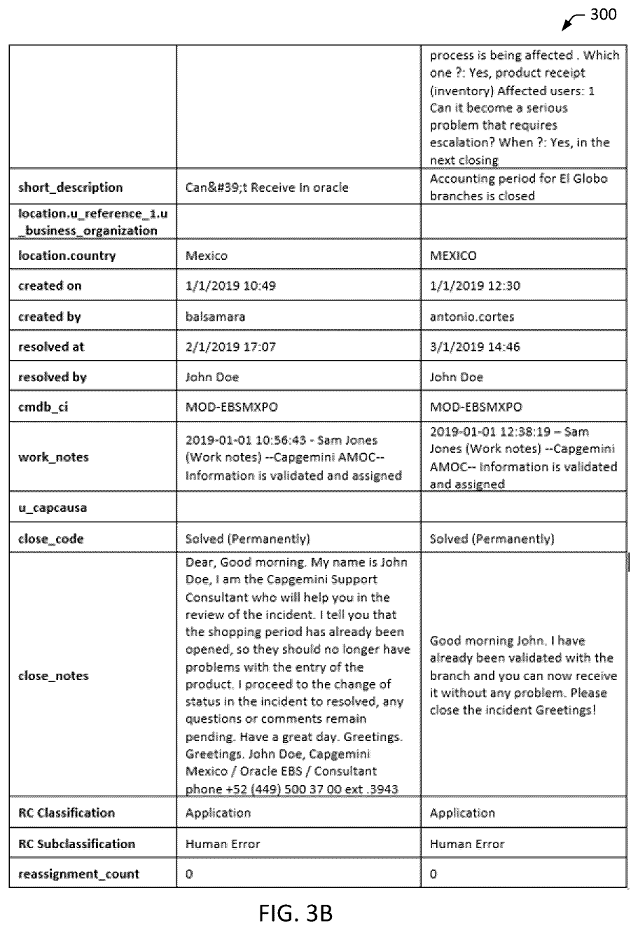

FIGS. 3A and 3B are diagrams that illustrate example ticket data 300 in accordance with one or more embodiments. In the illustrated embodiment, the attributes of the ticket data 300 generally correspond to those of ticket data attributes 200 of FIG. 2, with the ticket data 300 including examples of respective sets respective ticket data 302a and 302b. The first ticket data 302a may be populated attribute values of a first work ticket 130, and the second ticket data 302b may be populated attribute values of a second work ticket 130. Notably, each of the respective sets of ticket data 302a and 302b includes a value (e.g., a name) in both of the “assignment_group” and the “assigned_to” attribute fields. In certain embodiments, these fields may not be populated initially in the ticket data 300 for a ticket 130 and may be populated in response to determining of an agent group 108 or agent 106 to which the ticket 130 is to be assigned. For example, both of the “assignment group” and the “assigned_to” fields may be blank upon generation and submission of the work ticket 130 by a user 104, with the “assignment_group” field being populated with “CAP-IC-PO_IP_OS_ISP” in response to determining that it is the agent group 108 to which the work ticket 130 should be assigned, and the “assigned_to” field being populated with “John Doe” in response to determining that John is the specific agent 106 to which the work ticket 130 should be assigned within the agent group 108.

A work ticket 130 may be submitted through any suitable ticketing communication channel, such as virtual agents, phone, email, service portals, live agents, in person, or the like. A user 104 (e.g., user 104a or 104b) may include a person or other entity (e.g., a computer system) that submits a work ticket 130 (or associated request). In some embodiments, a user 104 is internal to the management system 102. Continuing with the example of a TSO, a user 104 may be a ticket intake agent (e.g., an employee or system) of the TSO that receives a request (e.g., from another internal or external user) concerning an issue (e.g., an issue involving the hardware, software, or electronic devices of the CI), and that generates a corresponding work ticket 130 that outlines the request for assistance (e.g., including the intake agent populating the work ticket 130 with the ticket data 302a of FIGS. 3A and 3B in response to receiving the request from the other user). In some embodiments, a user 104 is external to the management system 102. Continuing with the example of a TSO, a user 104 may be a customer (e.g., a person or system) that has a request for assistance concerning an issue (e.g., an issue involving the hardware, software, or electronic devices of the CI), and that generates and submits a corresponding work ticket 130 (e.g., including the customer populating the work ticket 130 with the ticket data 302a of FIGS. 3A and 3B) that outlines the request for assistance. Embodiments may include different users 104 (e.g., internal or externals users 104) populating portions of a work ticket 130. For example, a customer may populate a first subset of attribute values of a work ticket 130, and an intake agent may populate a second subset of attribute values of a work ticket 130. In some embodiments, a user 104 includes or employs a computer system that is the same or similar to that of computer system 1000 described with regard to at least FIG. 9.

An agent 106 (e.g., agent 106a or 106b) may include a person or other entity (e.g., a computer system) that has expertise in resolving issues, such as issues raised in work tickets 130. In some embodiments, an agent 106 is internal to the management system 102. Continuing with the example of a TSO, an agent 106 may be an IT service agent (e.g., an IT employee or system) of the TSO that is tasked with resolving assigned issues (e.g., tasked with resolving issues involving the hardware, software, or electronic devices of the CI). As described, an agent 106 may receive work ticket 130 that outlines the request for assistance with an issue, work to resolve the issue (e.g., including solving the issue), and report the outcome of the work to resolve the issue (e.g., reporting the resolution to the ticketing engine 110, the requesting user 104, or other interested entities). In some embodiments, an agent 106 includes or employs a computer system that is the same or similar to that of computer system 1000 described with regard to at least FIG. 9.

In some embodiments, a ticket assignment log 132 indicates characteristics of historical assignments of work tickets 130 to agents 106 or agent groups 108. For example, a ticket assignment log 132 may include a mapping of work tickets 130 (and associated work ticket data 300) to respective agents 106 or agent groups 130. In some embodiments, a ticket assignment log 132 may include, for each respective set of ticket data for a work ticket 130, a mapping to a given assigned agent group 108a. A ticket assignment log 132 may, for example, be similar to that of the illustrated ticket data 300 of FIGS. 3A and 3B, which include, for each of ticket data 302a and 302b, a mapping to a given assigned agent group 108. For example, in the illustrated embodiment, each of ticket data 302a and 302b includes the “assignment_group” field populated with “CAP-IC-PO_IP_OS_ISP,” which maps the respective sets of ticket data 302a and 302b to the agent group 108 of “CAP-IC-PO_IP_OS_ISP,” and each of ticket data 302a and 302b includes the “assigned_to” field being populated with “John Doe,” which maps the respective sets of ticket data 302a and 302b to the agent 106 of “John Doe.” In some embodiments, such agent or agent group assignments are populated into ticket data for a work ticket 130 in response to assignment of the work ticket 130 to an agent group or agent. For example, ticketing engine 110 may, receive an “unassigned” work ticket 130 having the “assignment_group” and “assigned_to” fields unpopulated, determine an agent group 108 and an agent 106 to which the work ticket 130 is to be assigned, and in response to the assignments, populate the respective fields with values indicative of the assigned agent group 108 and agent 106. The associated ticket data 300 may be stored in a ticket assignment log 132 of the ticketing database 112.

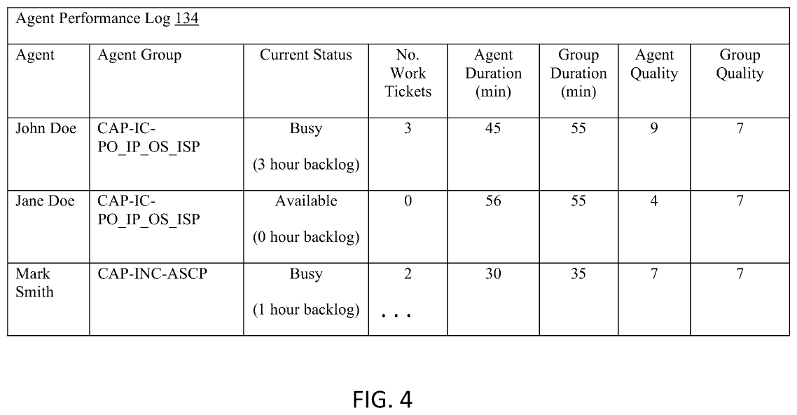

In some embodiments, an agent performance log 134 includes data that indicates characteristics of historical handling of work tickets by agents 106 or agent groups 108. For example, an agent performance log 134 may include, for each of different agents 106, an indication of the agent group of which the agent 106 is a member, a current status (e.g., busy or available), a number of tickets handled (e.g., an indication of a number of tickets handled by the agent 106 over a given period of time, such as since beginning work as an agent in the agent group, the last 30 days, or the like), agent duration (e.g., an average or mean of the amount of time from assignment to closing of work tickets assigned to the agent 106), agent group duration (e.g., an average or mean of the amount of time from assignment to closing of work tickets assigned to the agent group 108 that the agent 106 belongs to), an agent quality scoring (e.g., an average or mean of user or system provided scoring of the quality of resolutions provided by the agent 106), a group quality scoring (e.g., an average or mean of user or system provided scoring of the quality of resolutions provided by the agent group 108 that the agent 106 belongs to), ticket handling (e.g., an indication of how many times an agent has reassigned tickets, such as escalating tickets to another agent with greater expertise), or the like. FIG. 4 is a diagram that illustrates example agent performance log 134 in accordance with one or more embodiments.

Ticket performance data 144 may include data that indicates characteristics of historical outcomes of work tickets 130 or efforts by agents 106 or agent groups 108. For example, a ticket performance data 144 may include work ticket performance data indicative of characteristics of the processing of work tickets 130 by the management system 102, or agent performance data indicative of characteristics of the processing of work tickets 130 by an agent 106 or agent group 108 of the management system 102. Work ticket performance data may include, for example, for respective work tickets 130, attribute values for a completion status (e.g., open, closed, etc.), a duration (e.g., an amount of time from assignment to closing of the work ticket 130), a number of assignments (e.g., indicative of the number of agents assigned the ticket between opening and closing of the work ticket 130), a quality scoring (e.g., an indication of the quality of the resolution of the issue of the work ticket 130 provided by the user 104 that submitted the work ticket), or the like. Agent performance data may include, for example, for each of respective agents 106, an indication of the agent group of which the agent 106 is a member, a status (e.g., busy or available), a number of tickets handled (e.g., an indication of ticket handled by the agent 106 over a given period of time, such as since beginning work, over the last 30 days, or the like), agent duration (e.g., an average or mean of the amount of time from assignment to closing of work tickets assigned to the agent 106), agent group duration (e.g., an average or mean of the amount of time from assignment to closing of work tickets assigned to the agent group 108 the agent 106 belongs to), a quality scoring (e.g., an average or mean of user or system provided scoring of the quality of resolutions provided by the agent 106), ticket handling (e.g., an indication of how many times an agent has reassigned tickets, such as escalating tickets to another agent with greater expertise), or the like.

In some embodiments, a ticket assignment log 132 incorporates aspects of ticket performance data 144 indicative of characteristics of the processing of work tickets 130 by the management system 102. For example, the ticket assignment log 132 may be updated to include, for each of different work tickets 130, associated ticket data 300 merged with aspects of ticket performance data 144 that are associated with the work ticket 130. The ticket assignment log 132 may include, for example, for the first set of ticket data 302a, the data listed under “Ticket 1 Data” in FIGS. 3A and 3B, along with attributes for a completion status (e.g., open, closed, etc.), a duration (e.g., an amount of time from assignment to closing of the work ticket 130), a number of assignments (e.g., indicative of the number of agents assigned the ticket between opening and closing of the work ticket 130), a quality scoring (e.g., an indication of the quality of the resolution of the issue of the work ticket 130 provided by the user 104 that submitted the work ticket 106), or the like. In such an embodiment, the ticket assignment log 132 may provide relatively complete insight for work tickets 130, including characteristics of the basis of the work tickets 130 and how the work tickets 130 were resolved.

In some embodiments, an agent performance log 134 incorporates aspects of ticket performance data 144 indicative of characteristics of historical handling of work tickets by agents 106 or agent groups 108 of the management system 102. For example, an agent performance log 134 may be generated based on agent performance data of ticket performance data 144 that is indicative of characteristics of the processing of work tickets 130 by an agent 106 or agent group 108.

As described here, in some embodiments, values for one or more of the respective attributes of the work tickets 130 may be used as a basis for routing work tickets 130 to certain agents 106 of the management system 102. For example, the ticketing engine 110 may receive a work ticket 130 associated with a technical issue to be resolved, determine an agent 106 to which the work ticket 130 is to be assigned based on the attributes of the work ticket 130 (e.g., based on a description of the issue contained in the work ticket 130), route the work ticket 130 to the agent 106, and monitor for ticket performance data 144 concerning resolution of the work tickets 130 and associated performance by the assigned agent(s) 106. As further described, in some embodiments, determining an agent 106 to which the work ticket 130 is to be assigned includes determining an agent group 108 to which the work ticket 130 is to be assigned based on the attributes of the work ticket 130 and, in response to determining an agent group 108 to which the work ticket 130 is to be assigned, determining a given agent 106 of the agent group 108 to which the work ticket 130 is to be assigned, based on characteristics of the agent 106 or agent group 108. For example, determining an agent 106 to which a work ticket 130 is to be assigned may include determining an agent group 108 to which the work ticket 130 is to be assigned based on a description of the issue contained in the work ticket 130 and, in response to determining the agent group 108, determining the agent 106a of the agent group 108 for assignment of the work ticket 130 based on the agent 106a having suitable experience, availability, quality scoring, or the like.

In some embodiments, determination of an agent group or agent for handing a work ticket is determined by way of artificial intelligence (AI) based modeling. For example, the ticketing models 138 may include a group mapping model 140 trained to determine an agent group 108 to which a work ticket 130 is to be assigned based on one or more attributes of the work ticket 130, such as a short (or full) description of the issue contained in the work ticket 130, and include an agent mapping model 142 trained to determine an agent 106 of an agent group 108 to which the work ticket 130 is to be assigned based on characteristics of the agent 106 or the agent group 108, such as experience, availability, quality scoring, or the like. Such an embodiment may provide an efficient and effective technique for narrowing assignment of a work ticket 130 to a particular agent group 108, which, in turn, enables a focused assessment of agents 106 within the agent group 108 for selection of a most suitable agent 106 for handling the work ticket 130. For example, the ticketing engine 110 may receive a work ticket 130 associated with a technical issue to be resolved, determine a description of the issue to be resolved based on the ticket data of the work ticket 130 (e.g., extract or generate a short description value of “unable to open software application”), apply the description of the issue to a group mapping model 140 (e.g., a machine learning model trained to predict agent group assignment of work tickets based on short description attribute values of work tickets) to identify a particular agent group 108 (e.g., to identify the Software IT Agent Group), assess the identified agent group 108 using an agent mapping model 142 (e.g., a machine learning model trained to predict a particular agent of an agent group to which a work ticket is to be assigned based on characteristics of the agent or the agent group) to identify (or “select”) an agent 106 of the agent group 108 that is experienced with the issue and available to handle the work ticket 130, and route the work ticket 130 to the agent 106.

In some embodiments, a group mapping model 140 is a machine learning model that is operable to determine an agent group to which a work ticket is to be assigned based on one or more attributes of the work ticket. For example, the group mapping model 140 may be a machine learning model employing one or more trained machine learning algorithms that are operable to determine an agent group 108 to which a work ticket 130 is to be assigned based on a short description of the issue contained in the work ticket 130. Although certain embodiments are described in the context of using a short description as an input vector of to which the work ticket 130 is to be assigned, other embodiments may employ any suitable combination of one or more relevant attributes of the work ticket 130, such as a full issue description, a location, or the like. In some embodiments, the group mapping model 140 is trained using historical structured data or historical unstructured data. For example, the group mapping model 140 may be trained using a ticket assignment log 132 that includes respective sets of ticket data 300 for past work tickets 130 that map respective sets of work ticket attributes (e.g., a short description of the issue contained in the work ticket 130, a full description of the issue contained in the work ticket 130, a location associated with the work ticket 130, or the like) to a work ticket assignment to a given agent group 108. In some embodiments, the group mapping model 140 employs a machine learning algorithm, such as Naive Bayes Classifier, Decision Trees, Random Forest, Support Vector Machines (SVM), K-Nearest Neighbors (KNN), Neural Networks, Ensemble Learning, Logistic Regression, Gradient Boosting, XGBoost, Deep Learning, or the like. For example, the group mapping model 140 may employ a Random Forest classifier model trained using a ticket assignment log 132 to determine an agent group 108 to which a work ticket 130 is to be assigned based on a short description of the issue contained in the work ticket 130.

In some embodiments, the group mapping model 140 employs a description model 141 that is operable to determine a description for use in determining an assigned agent group. For example, a description model 141 may employ a language model (e.g., a large language model (LLM)) that is trained to generate a description of a work ticket 130 based on attributes of the work ticket 130, such as a short description of the issue contained in the work ticket 130 or any other set of one or more other relevant attributes of the work ticket 130, such as a full issue description, a location, or the like. In such an embodiment, attributes of a work ticket 130 may be input (or “fed” or “applied”) to the description model 141, and the description model 141 may, in turn, generate a description of the work ticket 130 based on the attributes. The generated description of the work ticket 130 may, in turn, input to the group mapping model 140, and the group mapping model 140 may, in turn, determine an agent group 108 to which the work ticket 130 is to be assigned. That is, a language model may be used to generate, based on the content of the work ticket 130, a description that can be input to the group mapping model for determining a corresponding agent group 108 to which the work ticket 130 is to be assigned. In some embodiments, the description model 141 can be tuned to provide a suitable description. For example, the description model 141 can be tuned to provide a description of a given length (e.g., 5-10 words). Such tuning may help to enhance performance of the group mapping model 140. For example, a length of 5-10 words may be specified where, for example, it is determined that at least five words are needed in a description to provide a sufficient description to enable the group mapping model 140 to provide accurate predictions of agent groups for a work ticket, or descriptions of ten words or less enhance the speed of the group mapping model 140 while maintaining a significantly high level of accuracy. In some embodiments, a large language model is employed to condense a work ticket's 130 description to a more desirable length. This approach may be particularly useful for improving accuracy and expediting the assignment process. For example, when a work ticket's 130 description is overly lengthy or lacks clear structure (e.g., where a ticket includes unstructured data or text), the large language model may distill the content. Such a large language model may, for example, concisely rephrase and organize the essential information, removing redundancies and clarifying the core issue. This refinement can, for example, not only make the ticket more straightforward for the respective mapping models to comprehend, but also ensure that the most relevant details are highlighted, which may facilitate a more efficient and targeted response to assign the work ticket 130 to a proper agent group 108 and/or agent 106. In some embodiments, parameters such as description length, may be predetermined or may be automatically determined and adjusted overtime (e.g., by way of a machine learning model that determines an optimal description length based on mapping of description length to speed and accuracy of resulting predictions overtime).

In some embodiments, an agent mapping model 142 is a machine learning model that is operable to determine an agent of an agent group to which a work ticket is to be assigned based on one or more attributes of agents in the agent group. For example, the agent mapping model 142 may be trained using one or more machine learning algorithms to determine an agent 106 to which a work ticket 130 is to be assigned based on an identified agent group 108 and one or more attributes of agents 106 in the agent group 108, such as their availability (or predicted availability), an associated duration for the agent to complete a similar work ticket, or the like. Although certain embodiments are described using availability or durations, other embodiments may employ any suitable combination of one or more relevant characteristics of the agents, such as a number of currently assigned tickets, performance scores, agent expertise, or the like. In some embodiments, the agent mapping model 142 is trained using historical structured or unstructured data. For example, the agent mapping model 142 may be trained using an agent performance log 134 that indicates characteristics of historical handling of work tickets 130 by agents 106 of the agent group 108. In some embodiments, the agent mapping model 142 employs a specific machine learning algorithm, such as such as Naive Bayes Classifier, Decision Trees, Random Forest, Support Vector Machines (SVM), K-Nearest Neighbors (KNN), Neural Networks, Ensemble Learning, Logistic Regression, Gradient Boosting, XGBoost, Deep Learning, or the like. For example, the agent mapping model 142 may employ a Random Forest classifier model trained using an agent performance log 134 to determine an agent 106 of an identified agent group 108 to which a work ticket 130 is to be assigned based on characteristics of historical handling of work tickets by agents 106 of the agent group 108.

In some embodiments, the agent mapping model 142 employs one or more rules to effectuate efficient and effective selection of agents. For example, the agent mapping model 142 may be designed to determine an effective maximum workload for a given agent 106, and to avoid assigning work tickets 130 in a manner that would violate the maximum workload for the given agent 106. In some embodiments, the maximum workload is defined as an assigned number of tickets for an agent 106 at which the agent's performance is predicted to fall below a given threshold or otherwise diminish significantly. For example, where historical data shows that a given agent 106 has relatively low/acceptable resolution durations while handling 1-6 work tickets simultaneously but has a relatively high/un-acceptable resolution durations while handling 7 or more work tickets simultaneously, a maximum workload for the agent 106 may be defined as 6 work tickets. In such an embodiment, the agent mapping model 142 may remove the agent 106 from the pool of available agents within an agent group 108 or weight the agent 106 availability in the pool of available agents within an agent group 108 relatively low, to eliminate or reduce the likelihood of the agent 106 being assigned a ticket 130 that would cause exceeding of the maximum workload for the agent 106. In some embodiments, parameters such maximum workload for an agent, may be predetermined or may be automatically determined and adjusted overtime (e.g., by way of a machine learning model that determines, based on historical agent performance, an assigned number of tickets for an agent at which the agent's performance is predicted to fall below a given threshold or otherwise diminish significantly).

As another example, the agent mapping model 142 may be designed to determine a suitable workload distribution for a given agent 106, and to avoid assigning work tickets 130 in a manner that would violate the suitable workload distribution for the given agent 106. In some embodiments, the maximum workload distribution is defined as a ratio of a certain type of ticket assigned to an agent relative to the total number of assigned tickets for an agent 106 that maintains agent performance within an acceptable range. For example, where historical data shows that a given agent 106 has relatively low/acceptable resolution durations with a workload distribution of at most 50% of one type of work ticket issue but has a relatively high/un-acceptable resolution durations with a workload distribution of more than 50% of one type of work ticket issue, a maximum workload distribution for the agent 106 may be defined as 50%. In such an embodiment, the agent mapping model 142 may remove the agent 106 from the pool of available agents within an agent group 108, or weight the agent 106 availability in the pool of available agents within an agent group 108 relatively low, when a work ticket 130 would cause the workload distribution to exceed the maximum workload distribution for the agent 106, in an effort to eliminate or reduce the likelihood of the agent 106 being assigned a ticket 130 that would cause exceeding of the maximum workload distribution for the agent 106. In some embodiments, parameters such maximum workload distribution for an agent, may be predetermined or may be automatically determined and adjusted overtime (e.g., by way of a machine learning model that determines, based on historical agent performance, a distribution of work tickets for an agent at which the agent's performance is predicted to fall below a given threshold or otherwise diminish significantly).

In some embodiments, one or more attributes of agents 106 in the agent group 108 are determined based on model predictions for the attributes. For example, a forecasting model 143 may generate a forecast of availability of agents 106, including availability some or all of the agents 106 within a given agent group 108, and the forecast of availability of agents 106 may be input into the agent mapping model, along with the identity of the agent group 108 for a work ticket 130 determined by the group mapping model 140, and the agent mapping model 142 may, in turn, determine a given agent 106 of the agent group 108 to which the work ticket 130 should be assigned based at least in part on the forecast of availability.

In some embodiments, a forecasting model 143 is a machine learning model that is operable to determine predicted agent workload and corresponding availability based on historical workloads of agents. For example, the forecasting model 143 may be a machine learning model employing one or more trained machine learning algorithms that are operable to determine an availability of agents 106 of an agent group 108 to which a work ticket 130 is to be assigned based on historical agent availability and associated events, current events, and current levels of agent availability. Although certain embodiments are described in the context of using historical agent availability and associated events, current events, and current levels of agent availability, other embodiments may employ any suitable combination of one or more relevant attributes of agent availability. In some embodiments, the forecasting model 143 is trained using historical structured data or historical unstructured data. For example, the forecasting model 143 may be trained using a ticket assignment log 132 that includes respective sets of ticket data 300 for past work tickets 130 that map respective sets of work ticket attributes (e.g., date, time, description, assigned agent, or the like) to a duration of work ticket resolution (e.g., which is indicative of times and dates that an agent is unavailable). In some embodiments, the group mapping model 140 employs a machine learning algorithm, such as a time series model algorithm (e.g., AutoRegressive Integrated Moving Average (ARIMA)), a machine learning model algorithm (e.g., Linear Regression, Decision Trees, Gradient Boosting Algorithms (e.g., XGBoost, LightGBM, and CatBoost), Neural Networks (e.g., LSTM (Long Short-Term Memory), GRU (Gated Recurrent Unit), Feedforward Neural Networks, Seasonal Decomposition of Time Series (STL) model algorithms, text mining, clustering, segmenting, Deep Learning, or the like. For example, the forecasting model 143 may employ a Linear Regression model trained using a ticket assignment log 132 (e.g., indicative of historical agent availability), historical associated events, and agent availability data that is indicative of current agent availability, to determine availability of agents 106 of an agent group 108 to which a work ticket 130 is to be assigned.

Concerning the above-described machine learning algorithms, a given algorithm may be implemented based on its operation and characteristics. For example, Naive Bayes classification may assume independence between features, which may make it suitable for simple datasets with categorical features. Decision tree modeling may recursively split data based on feature values, which may make it effective for capturing complex decision-making processes with both categorical and numerical features. Random Forest modeling may construct multiple decision trees and combines their outputs, which may make it useful for reducing overfitting and improving accuracy by aggregating predictions. SVM modeling may find a hyperplane that maximally separates classes in a high-dimensional space, which may make it beneficial when a clear margin of separation exists. KNN modeling may classify a data point based on the majority class of its k nearest neighbors, which may benefit tasks emphasizing local similarity. Neural network modeling may create layers of interconnected nodes to learn hierarchical representations, which may be suitable for capturing complex, non-linear relationships in large datasets. Ensemble learning may combine predictions from multiple models to enhance overall performance, which may utilize techniques like bagging or boosting to boost accuracy and robustness. Logistic regression modeling may model the probability that a given instance belongs to a particular category, which may make it useful for problems requiring a probabilistic interpretation. Gradient boosting may build trees sequentially, with each tree correcting the errors of the previous ones and may be effective for combining weak learners to create a strong predictive model. XGBoost may be an ensemble learning technique suitable for handling both historical data and current availability features. Deep Learning may involve training artificial neural networks to perform tasks based on processing large amounts of data, which may provide for automated learning and adaptation to data updates.

In some embodiments, training of the group mapping model 140 or the agent mapping model 142 includes pre-processing of the ticket model training data set 136. This may include, for example, removing null attribute value fields of the ticket model training data set 136 employed by the models (e.g., removing null fields for short description, description, or the like), cleaning the text of the ticket model training data set 136 (e.g., fixing contractions, and removing URLs, HTMLs, non-ascii characters, punctuation, and stop words), or filtering or tagging certain work tickets 130 as “spam” in order to recognize and prevent “spam” tickets from being assigned.

In some embodiments, training of the group mapping model 140 or the agent mapping model 142 includes splitting the ticket model training data set 136 into a training data subset, a validation data subset, and a testing data subset. In such an embodiment, the training dataset may be used to train the machine learning model. During this phase, the model may learn patterns and relationships within the data. For example, the algorithm may process the training data, adjusting its parameters to minimize differences between its predicted output and the actual target values. This may be an iterative process that continues until the model achieves satisfactory performance. The validation dataset may be used to fine-tune the model and optimize its hyperparameters. This may provide an independent dataset not used during training to assess how well the model generalizes to new, unseen data. During this phase, after each training iteration, the model's performance is evaluated on the validation set. Based on this evaluation, hyperparameters (e.g., learning rate, regularization, etc.) may be adjusted to improve performance without overfitting to the training data. The testing dataset may be used to assess the model's final performance and generalization to new, unseen data. It may provide an unbiased evaluation of the model's ability to make predictions on data it has never encountered before. During this phase, the model, with its optimized parameters, may be evaluated on the testing set, and its performance metrics (e.g., accuracy, precision, recall, etc.) may be calculated. This evaluation may help to estimate how well the model is expected to perform on new, real-world data. Such evaluations and fine-tune can provide relatively accurate models and associated predictions. For example, models may reach accuracies of 80% or better, which can improve over time with supplemental training data and retraining.

FIG. 1B is diagram that illustrates operational aspects of a technical support environment 150 in accordance with one or more embodiments. In some embodiments, a work ticket 130a is submitted by a user 104a. The user 104a may, for example, be a customer and the work ticket 130a may include a customer generated request for assistance with opening a software application, including a short description value of “unable to open software application.” The work ticket 130a may be received by the ticket assignment module 122. Upon receipt of the work ticket 130, the ticket assignment module 122 may determine a description associated with the work ticket 130a. This may include, for example, extracting (e.g., from the value of the short description attribute) or generating (e.g., by way of application of the attribute values of the work ticket 130a to description model 141), a description of “unable to open software application.” In response to determining the description, the ticket assignment module 122 may, in turn, feed the description of “unable to open software application” into the group mapping model 140. The group mapping model 140 may, in turn, predict, based on the description, that the work ticket 130a is to be assigned to a “software” agent group 108a, which includes agents 106a and 106b. The ticket assignment module 122 may, in turn, determine that the work ticket 130a is to be assigned to the “software” agent group 108a. In response, the ticket assignment module 122 may feed the “software” agent group 108a as an input to the agent mapping model 142, along with agent data 146 that is indicative of the current status and other characteristics of agents 106 (e.g., agent expertise with resolving a particular issue, or current workload) within the “software” agent group 108a. In some embodiments, the agent data 146 includes data indicative of current availability of agents 106 of the agent group 108 or a forecast of availability of agents 106 of the agent group 108 (e.g., determined by way of the forecasting model 143, as described here). The agent mapping model 142 may, in turn, predict, based on the agent group 108a and the agent data 146, that the work ticket 130a is to be assigned to agent 106a of the “software” agent group 108a. The ticket assignment module 122 may, in turn, determine that the work ticket 130a is to be assigned to agent 106a of the “software” agent group 108a. In response to the determination, the ticket assignment module 122 may assign work ticket 130a to agent 106a. In turn, agent 106a may work to resolve the work ticket 130a and report updates on resolving the issue of the work ticket 130a to the ticket assignment module 122. The ticket assignment module 122 may report performance information concerning the work ticket 130 to the ticket performance module 124, which may, in turn, generate corresponding ticket performance data 144, and incorporate respective portions of the ticket performance data 144 into the ticket assignment log 132 and the agent performance log 134. In some embodiments, the ticketing models 138 are trained based on a ticket model training data set 136, which includes work tickets 130, the ticket assignment log 132 and the agent performance log 134. For example, the ticketing model training module 120 may train the group mapping model 140 using the ticket assignment log 132 (e.g., which may incorporate some or all of the data of the work tickets 130) and train the agent mapping model 142 using the agent performance log 134. Such training may include an initial training of the ticketing models 138 (e.g., before processing of the ticket 130a) or a retraining of the ticketing models 138 based on updated versions of the ticket raining dataset 136 (e.g., after processing of the ticket 130a and updating the ticket assignment log 132 and the agent performance log 134 to reflect assignment and resolution of the work ticket 130a). Such an embodiment may provide an efficient and effective feedback loop that provides for training and updating of the group mapping model 140 and the agent mapping model 142, which can be applied in sequence for determining an appropriate agent group 108 and agent 106 for assignment of a work ticket 130.

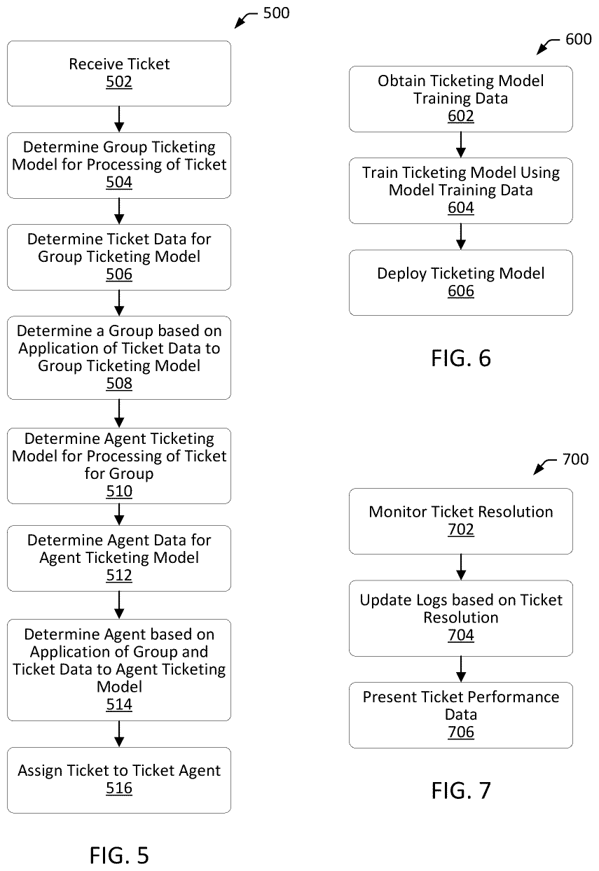

FIG. 5 is a flowchart diagram that illustrates a method 500 of assigning work tickets in accordance with one or more embodiments. Some or all of the procedural elements of method 500 may be performed, for example, by the ticketing engine 110, the assignment module 122, or another entity.

Method 500 may include receiving a ticket (block 502). This may include receiving a work ticket outlining a request for assistance with an issue. For example, receiving a ticket may include the assignment module 122 receiving, from a user 104a, a work ticket 130a outlining a request for assistance with opening a software application, including a short description value of “unable to open software application.”

Method 500 may include determining a group ticketing model for processing of a ticket (block 504). This may include determining a machine learning model for use in predicting a group to which a work ticket 130a is to be assigned. For example, determining a group ticketing model for use in processing of a ticket may include the assignment module 122 determining the group mapping model 140 for use in processing of the work ticket 130a. The group mapping module 140 may be a trained machine learning model as described herein.

Method 500 may include determining ticket data for a group ticketing model (block 506). This may include determining input data for a machine learning model for use in predicting a group to which a work ticket is to be assigned. For example, determining ticket data for a group ticketing model may include the assignment module 122 determining a “description” type attribute input for the group mapping model 140, and, in turn, determining (e.g., extracting or generating) a description of “unable to open software application.” As described, such a description may be extracted from a “short_description” attribute value of the ticket data of the work ticket 130a, or may be generated based on the attribute values of the ticket data of the work ticket 130a. For example, the description of “unable to open software application” may be generated based on application of one or more attribute values of the ticket data of the work ticket 130a to the description model 141. The one or more attribute values applied to the description model 141 may be for example, the “short_description” attribute value, the “short_description” attribute value and the description” attribute value, or one or more other attribute values of the ticket data of the work ticket 130a.

Method 500 may include determining a group based on application of ticket data to a group ticketing model (block 508). This may include determining an agent group to which a work ticket is to be assigned, based on application of ticket data for the work ticket to a machine learning model determined for use in predicting a group to which the work ticket is to be assigned. For example, determining a group based on application of ticket data to a ticketing model may include the assignment module 122 feeding the description of “unable to open software application” into the group mapping model 140, and the group mapping model 140, in turn, predicting, based on the description, that the work ticket 130a is to be assigned to a “software” agent group 108a, that includes agents 106a and 106b. The ticket assignment module 122 may, in response, determine that the work ticket 130a is to be assigned to the “software” agent group 108a.

Method 500 may include determining an agent ticketing model for processing of a ticket for a group (block 510). This may include determining a machine learning model for use in predicting an agent to which a work ticket is to be assigned, within a determined group. For example, determining an agent ticketing model for processing of a ticket for a group may include the assignment module 122 determining the agent mapping model 142 for use in processing of the work ticket 130a for the “software” agent group 108a. The agent mapping model 142 may be a trained machine learning model as described herein.

Method 500 may include determining agent data for an agent ticketing model (block 512). This may include determining input data for a machine learning model for use in predicting an agent to which a work ticket is to be assigned, within a determined group. For example, determining agent data for an agent ticketing may include the assignment module 122 determining agent data 146 to be applied to the agent mapping model 142. The agent data 146 may, for example, include data indicative of current availability of agents 106 of the agent group 108a, a forecast of availability of agents 106 of the agent group 108a (e.g., determined by way of the forecasting model 143, as described here), or the like.

Method 500 may include determining an agent based on application of group and agent data to an agent ticketing model (block 514). This may include determining an agent to which a work ticket is to be assigned, based on application of an identified group and agent data for the identified group to a machine learning model determined for use in predicting an agent to which the work ticket is to be assigned, from within the group. For example, determining an agent based on application of group and agent data to an agent ticketing model may include the assignment module 122 feed the “software” agent group 108a as an input to the agent mapping model 142, along with agent data 146 that is indicative of the current status and other characteristics of agents 106 within the “software” agent group 108a, and the agent mapping model 142, in turn, predicting, that the work ticket 130a is to be assigned to agent 106a of the “software” agent group 108a. The ticket assignment module 122 may, in response, determine that the work ticket 130a is to be assigned to agent 106a of the “software” agent group 108a.

Method 500 may include assigning a ticket to an agent (block 516). This may include assigning a work ticket to an agent identified for handling resolution of the work ticket. For example, assigning a ticket to an agent may include the assignment module 122, in response to determining that the work ticket 130a is to be assigned to agent 106a of the “software” agent group 108a, assigning the work ticket 130a to agent 106a. As described, agent 106a may work to resolve the work ticket 130a and report updates on resolving the issue of the work ticket 130a to the ticket assignment module 122.

FIG. 6 is a flowchart diagram that illustrates a method 600 of training ticketing models in accordance with one or more embodiments. Some or all of the procedural elements of method 600 may be performed, for example, by the ticketing engine 110, the training module 120, or another entity.

Method 600 may include obtaining ticketing model training data (block 602). This may include obtaining model training data that is indicative of assigned agent groups for work tickets including various attribute values, that is indicative of availability and characteristics of agents within an agent group, or the like. For example, obtaining ticketing model training data may include the training module 120 obtaining a ticket training data set 136, which may include a ticket assignment log 132, an agent performance log 134, or the like.

Method 600 may include training a ticketing model using training data (block 604). This may include training a machine learning model based on a corresponding dataset. For example, training a ticketing model using training data may include the training module 120 training the group mapping model 140 using the ticket assignment log 132 or training the agent mapping model 142 using the agent performance log 134. In some embodiments, training a ticketing model using training data may include the training module 120 training the description model 141 or the forecasting model 143, as described here.

Method 600 may include deploying a ticketing model (block 606). This may include employing a ticketing model to predict or otherwise determine and output based on a set of model inputs. For example, deploying a ticketing model may include the training module 120 providing the group mapping model 140 for use in predicting an agent group for assignment of a work ticket 130 based on attribute values of the work ticket 130, such as a description of the work ticket 130. This may include, for example, the assignment module 122 feeding the description of “unable to open software application” into the group mapping model 140, and the group mapping model 140, in turn, predicting, based on the description, that the work ticket 130a is to be assigned to a “software” agent group 108a, that includes agents 106a and 106b (as described with regard to at least block 508 of FIG. 5). As another example, deploying a ticketing model may include the training module 120 providing the agent mapping model 142 for use in predicting an agent for assignment of a work ticket 130 based on an identified group and agent data for the identified group. This may include, for example, the assignment module 122 feeding the “software” agent group 108a as an input to the agent mapping model 142, along with agent data 146 that is indicative of the current status and other characteristics of agents 106 within the “software” agent group 108a, and the agent mapping model 142, in turn, predicting, that the work ticket 130a is to be assigned to agent 106a of the “software” agent group 108a (as described with regard to at least block 514 of FIG. 5).

As described, such embodiments may provide an efficient and effective feedback loop that provides for training and updating of the group mapping model 140 and the agent mapping model 142, which can be applied in sequence for determining an appropriate agent group 108 and agent 106 for assignment of a work ticket 130.

FIG. 7 is a flowchart diagram that illustrates a method 700 of monitoring work tickets in accordance with one or more embodiments. Some or all of the procedural elements of method 700 may be performed, for example, by the ticketing engine 110, the ticket performance module 124, or another entity.

Method 700 may include monitoring ticket resolution (block 702). This may include obtaining data that is indicative of assignments of work tickets, performance of agents handling tickets, availability of agents, or the like, as work tickets progress though the system. For example, monitoring ticket resolution may include the ticket performance module 124 obtaining ticket performance data 144. This may include, for example, obtaining data that indicates characteristics of historical outcomes of work tickets 130 or efforts by agents 106 (e.g., by agents 106a and 106b) or agent groups 108 (e.g., by “software” agent group 108a including agents 106a and 106b). For example, ticket performance data 144 may include work ticket performance data indicative of characteristics of the processing of work tickets 130 by the management system 102, or agent performance data indicative of characteristics of the processing of work tickets 130 by an agent 106 or agent group 108 of the management system 102.

Method 700 may include updating logs based on ticket resolution (block 704). This may include updating performance logs to reflect obtained ticket resolution data. For example, updating logs based on ticket resolution may include the ticket performance module 124 obtaining or generating corresponding performance data 144 (e.g., based on obtained ticket resolution data), and modifying the ticket assignment log 132 and the agent performance log 134 to incorporate respective portions of the performance data 144 therein. As described, in some embodiments, ticketing models 138 may be trained based on a ticket training data set 136, which includes the updated ticket assignment log 132 and the updated agent performance log 134 (as described with regard to at least block 602 of FIG. 6).

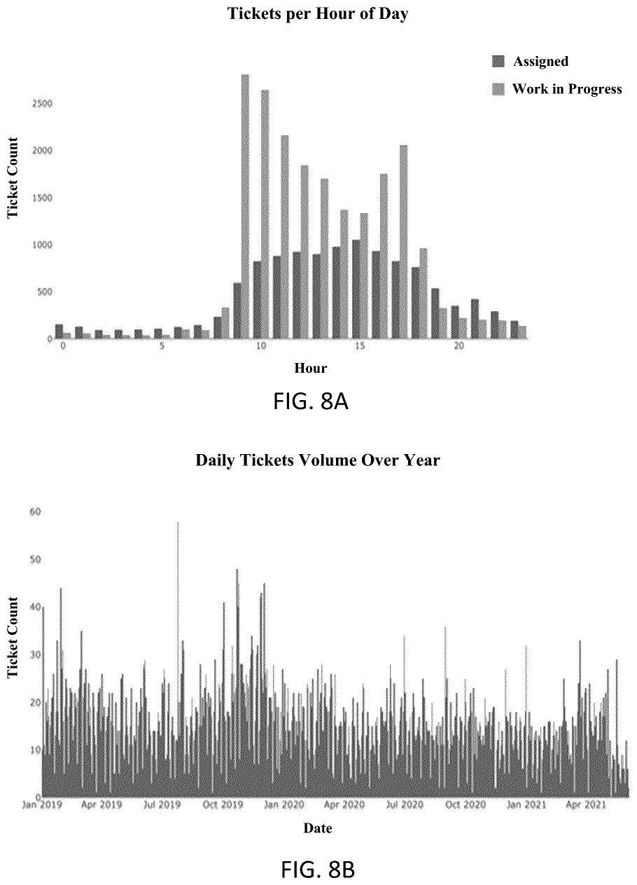

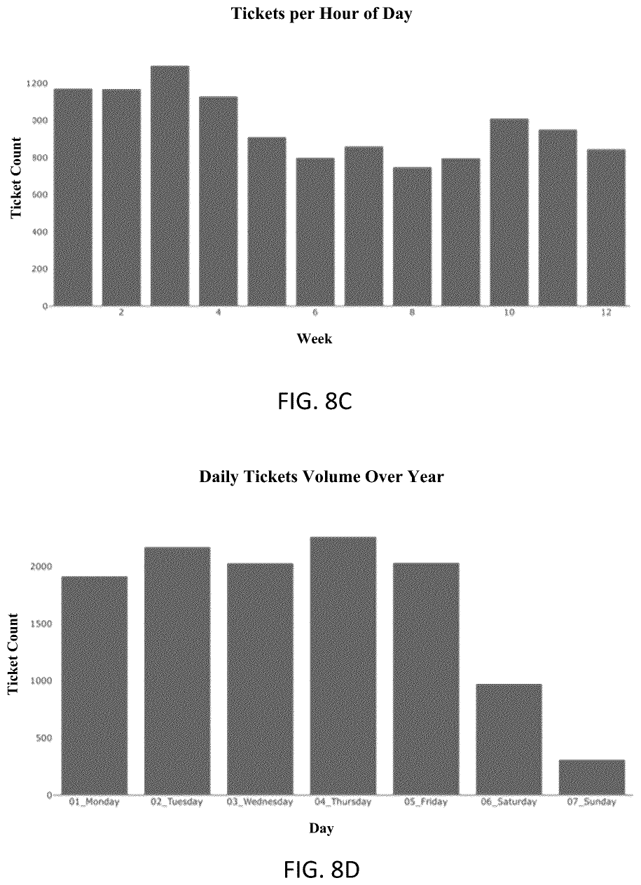

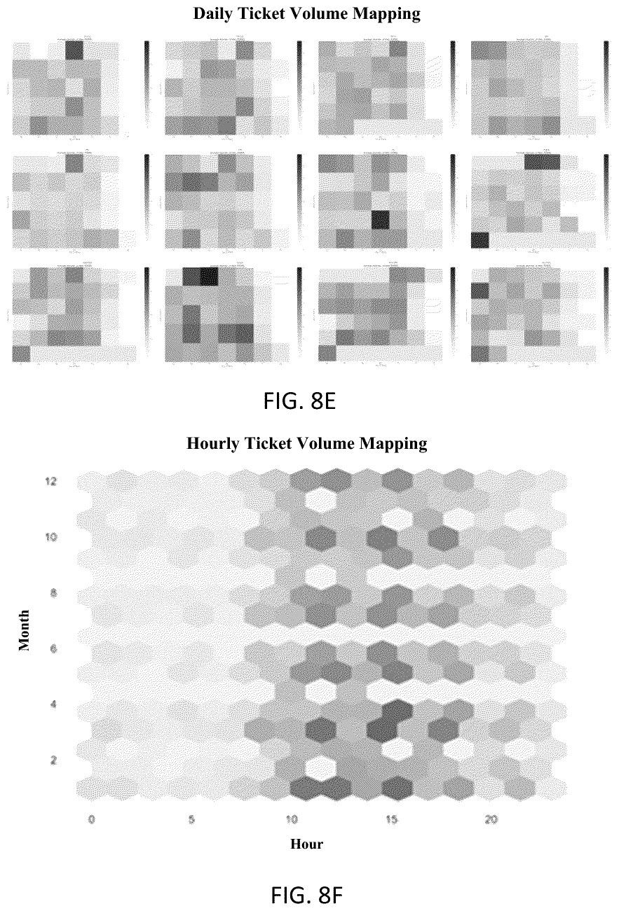

Method 700 may include presenting ticket performance data (block 706). This may include presenting data regarding ticket processing, such as historical data or forecast data. For example, presenting ticket performance data may include the ticket performance module 124 presenting, for output via a graphical display, graphs/charts indicative of past work ticket volumes (e.g., determined based on the ticket assignment log 132 and/or the agent performance log 134) or forecast ticket volumes (e.g., determined by the forecasting model 143 based on historical work ticket data, current events, predicted events, or the like). FIGS. 8A-8F are diagrams that illustrate example reportings in accordance with one or more embodiments. FIG. 8A is a diagram that illustrates an example distribution of volume of assigned and in-progress work tickets (e.g., an observed or forecast/predicted ticket count) across respective hours of a day. FIG. 8B is a diagram that illustrates an example distribution of volume of received work tickets (e.g., an observed or forecast/predicted ticket count) across respective days of a year. FIG. 8C is a diagram that illustrates an example distribution of volume of received work tickets (e.g., an observed or forecast/predicted ticket count) across respective weeks of a period of twelve weeks. FIG. 8D is a diagram that illustrates an example distribution of volume of received work tickets (e.g., an observed or forecast/predicted ticket count) across respective days of a week. FIG. 8E is a diagram that illustrates an example heat map illustrating distribution of daily volume of received work tickets (e.g., an observed or forecast/predicted ticket count) across respective days of a year (with the days grouped by month and illustrated in a monthly calendar arrangement). FIG. 8F is a diagram that illustrates an example heat map illustrating the distribution of hourly volume of received work tickets (e.g., an observed or forecast/predicted ticket count) across respective hours of days of a year. Such reportings may enable persons to quickly understand, observe, or forecast/predict trends regarding ticket count. In the case of observed trends, the reportings may enable a person to understand historical trends which may help to diagnose past issues and successes, and plan accordingly (e.g., including staffing of agents to reduce issues and increase success). In the case of forecast/predicted trends, the reportings may enable a person to understand expected trends which may help to diagnose potential issues and successes, plan accordingly (e.g., including staffing of agents to reduce issues and increase success, or scheduling trainings for certain agents that lack expertise), develop KPI metrics and benchmarks, or the like.

FIG. 9 is a diagram that illustrates an example computer system (or “system”) 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to the entities described (e.g., management system 102, users 104, agents 106, training module 120, assignment module 122, or ticket performance module 124) or method 500, 600, or 700.

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display screen (e.g., an electronic display for displaying a graphical user interface (GUI)). The I/O devices 1014 may include one or more of the user input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A work ticket management system comprising:
a ticketing database storing ticketing data comprising:
   a group mapping model trained to determine an agent group corresponding to the technical issue based on an issue description; and
   an agent mapping model trained to determine an agent of the agent group for resolving the technical issue based on identification of the agent group; and
non-transitory computer readable storage medium comprising program instructions stored thereon that are executable by a processor to perform the following operations for managing work tickets:
receiving, by a work ticket engine, a work ticket comprising a textual description of a technical issue to be resolved;
determining, by the work ticket engine based on the textual description, ticket data comprising an issue description indicative of the technical issue to be resolved;
determining, by the work ticket engine based on application of the issue description to the group mapping model, an agent group corresponding to the technical issue;
determining, by the work ticket engine based on application of the agent group to the agent mapping model, an agent of the group for resolving the technical issue; and
providing, by the work ticket engine in response to determining the agent of the group for resolving the technical issue, the work ticket to the agent.

2. The system of embodiment 1, the operations further comprising the agent, in response to the assignment of the work ticket to the agent, attending to resolving the work ticket.

3. The system of embodiment 1 or embodiment 2, the operations further comprising:
determining, by the work ticket engine, ticket performance data indicative of assignment of the work ticket to the agent and resolution of the work ticket by an agent;
training, by the work ticket engine based on ticket performance data indicative of the assignment of the work ticket to the agent, the group mapping model; and
training, by the work ticket engine based on ticket performance data indicative of the resolution of the work ticket by an agent, the agent mapping model.

4. The system of any one of embodiments 1-3, the operations further comprising:
obtaining, by the work ticket engine, a ticketing model training dataset comprising a ticket assignment log comprising an indication of historical assignments of work tickets to agent groups; and
training, by the work ticket engine based on the ticketing model training dataset, the group mapping model to identify an agent group for assignment of a work ticket based on an issue description indicative of a technical issue corresponding to the work ticket.

5. The system of any one of embodiments 1-4, the operations further comprising:
obtaining, by the work ticket engine, a ticketing model training dataset comprising a ticket performance log comprising an indication of characteristics of historical resolution of work tickets by agents; and
training, by the work ticket engine based on the ticketing model training dataset, the agent mapping model to identify an agent for assignment of a work ticket based on an identified agent group for the work ticket.

6. The system of any one of embodiments 1-5, wherein determining the agent of the group for resolving the technical issue comprises:
determining, by the work ticket engine based on application of the agent group and agent data comprising a forecast of agent availability to the agent mapping model, the agent of the group for resolving the technical issue.

7. A method of managing work tickets, the method comprising:
receiving, by a work ticket engine, a work ticket comprising a textual description of a technical issue to be resolved;
determining, by the work ticket engine based on the textual description, ticket data comprising an issue description indicative of the technical issue to be resolved;
determining, by the work ticket engine based on application of the issue description to a group mapping model, an agent group corresponding to the technical issue;
determining, by the work ticket engine based on application of the agent group to an agent mapping model, an agent of the group for resolving the technical issue; and
providing, by the work ticket engine in response to determining the agent of the group for resolving the technical issue, the work ticket to the agent.

8. The method of embodiment 7, further comprising the agent, in response to the assignment of the work ticket to the agent, attending to resolving the work ticket.

9. The method of embodiment 7 or embodiment 8, further comprising:
determining, by the work ticket engine, ticket performance data indicative of assignment of the work ticket to the agent and resolution of the work ticket by an agent;
training, by the work ticket engine based on ticket performance data indicative of the assignment of the work ticket to the agent, the group mapping model; and
training, by the work ticket engine based on ticket performance data indicative of the resolution of the work ticket by an agent, the agent mapping model.

10. The method of any one of embodiments 7-9, further comprising:
obtaining, by the work ticket engine, a ticketing model training dataset comprising a ticket assignment log comprising an indication of historical assignments of work tickets to agent groups; and
training, by the work ticket engine based on the ticketing model training dataset, the group mapping model to identify an agent group for assignment of a work ticket based on an issue description indicative of a technical issue corresponding to the work ticket.

11. The method of any one of embodiments 7-10, further comprising:
obtaining, by the work ticket engine, a ticketing model training dataset comprising a ticket performance log comprising an indication of characteristics of historical resolution of work tickets by agents; and
training, by the work ticket engine based on the ticketing model training dataset, the agent mapping model to identify an agent for assignment of a work ticket based on an identified agent group for the work ticket.

12. The method of any one of embodiments 7-11, wherein determining the agent of the group for resolving the technical issue comprises:
determining, by the work ticket engine based on application of the agent group and agent data comprising a forecast of agent availability to the agent mapping model, the agent of the group for resolving the technical issue.

13. A non-transitory computer readable storage medium comprising program instructions stored thereon that are executable by a processor to cause performance of the method of any one of claims 7-12.

What is claimed is:

1. A work ticket management system comprising:
a ticketing database storing ticketing data comprising:
a group mapping model trained to determine an agent group corresponding to the technical issue based on an issue description; and
an agent mapping model trained to determine an agent of the agent group for resolving the technical issue based on identification of the agent group; and
non-transitory computer readable storage medium comprising program instructions stored thereon that are executable by a processor to perform the following operations for managing work tickets:
receiving, by a work ticket engine, a work ticket comprising a textual description of a technical issue to be resolved;
determining, by the work ticket engine based on the textual description, ticket data comprising an issue description indicative of the technical issue to be resolved;
determining, by the work ticket engine based on application of the issue description to the group mapping model, an agent group corresponding to the technical issue;
determining, by the work ticket engine based on application of the agent group to the agent mapping model, an agent of the group for resolving the technical issue; and
providing, by the work ticket engine in response to determining the agent of the group for resolving the technical issue, the work ticket to the agent.

2. The system of claim 1, the operations further comprising the agent, in response to the assignment of the work ticket to the agent, attending to resolving the work ticket.

3. The system of claim 1, the operations further comprising:
determining, by the work ticket engine, ticket performance data indicative of assignment of the work ticket to the agent and resolution of the work ticket by an agent;
training, by the work ticket engine based on ticket performance data indicative of the assignment of the work ticket to the agent, the group mapping model; and
training, by the work ticket engine based on ticket performance data indicative of the resolution of the work ticket by an agent, the agent mapping model.

4. The system of claim 1, the operations further comprising:
obtaining, by the work ticket engine, a ticketing model training dataset comprising a ticket assignment log comprising an indication of historical assignments of work tickets to agent groups; and
training, by the work ticket engine based on the ticketing model training dataset, the group mapping model to identify an agent group for assignment of a work ticket based on an issue description indicative of a technical issue corresponding to the work ticket.

5. The system of claim 1, the operations further comprising:
obtaining, by the work ticket engine, a ticketing model training dataset comprising a ticket performance log comprising an indication of characteristics of historical resolution of work tickets by agents; and
training, by the work ticket engine based on the ticketing model training dataset, the agent mapping model to identify an agent for assignment of a work ticket based on an identified agent group for the work ticket.

6. The system of claim 1, wherein determining the agent of the group for resolving the technical issue comprises:
determining, by the work ticket engine based on application of the agent group and agent data comprising a forecast of agent availability to the agent mapping model, the agent of the group for resolving the technical issue.

7. A method of managing work tickets, the method comprising:
receiving, by a work ticket engine, a work ticket comprising a textual description of a technical issue to be resolved;
determining, by the work ticket engine based on the textual description, ticket data comprising an issue description indicative of the technical issue to be resolved;
determining, by the work ticket engine based on application of the issue description to a group mapping model, an agent group corresponding to the technical issue;
determining, by the work ticket engine based on application of the agent group to an agent mapping model, an agent of the group for resolving the technical issue; and
providing, by the work ticket engine in response to determining the agent of the group for resolving the technical issue, the work ticket to the agent.

8. The method of claim 7, further comprising the agent, in response to the assignment of the work ticket to the agent, attending to resolving the work ticket.

9. The method of claim 7, further comprising:
determining, by the work ticket engine, ticket performance data indicative of assignment of the work ticket to the agent and resolution of the work ticket by an agent;
training, by the work ticket engine based on ticket performance data indicative of the assignment of the work ticket to the agent, the group mapping model; and
training, by the work ticket engine based on ticket performance data indicative of the resolution of the work ticket by an agent, the agent mapping model.

10. The method of claim 7, further comprising:
obtaining, by the work ticket engine, a ticketing model training dataset comprising a ticket assignment log comprising an indication of historical assignments of work tickets to agent groups; and
training, by the work ticket engine based on the ticketing model training dataset, the group mapping model to identify an agent group for assignment of a work ticket based on an issue description indicative of a technical issue corresponding to the work ticket.

11. The method of claim 7, further comprising:
obtaining, by the work ticket engine, a ticketing model training dataset comprising a ticket performance log comprising an indication of characteristics of historical resolution of work tickets by agents; and
training, by the work ticket engine based on the ticketing model training dataset, the agent mapping model to identify an agent for assignment of a work ticket based on an identified agent group for the work ticket.

12. The method of claim 7, wherein determining the agent of the group for resolving the technical issue comprises:
determining, by the work ticket engine based on application of the agent group and agent data comprising a forecast of agent availability to the agent mapping model, the agent of the group for resolving the technical issue.

13. A non-transitory computer readable storage medium comprising program instructions stored thereon that are executable by a processor to perform the following operations for managing work tickets:
receiving, by a work ticket engine, a work ticket comprising a textual description of a technical issue to be resolved;
determining, by the work ticket engine based on the textual description, ticket data comprising an issue description indicative of the technical issue to be resolved;
determining, by the work ticket engine based on application of the issue description to a group mapping model, an agent group corresponding to the technical issue;
determining, by the work ticket engine based on application of the agent group to an agent mapping model, an agent of the group for resolving the technical issue; and
providing, by the work ticket engine in response to determining the agent of the group for resolving the technical issue, the work ticket to the agent.

14. The medium of claim 13, the operations further comprising the agent, in response to the assignment of the work ticket to the agent, attending to resolving the work ticket.

15. The medium of claim 13, the operations further comprising:
determining, by the work ticket engine, ticket performance data indicative of assignment of the work ticket to the agent and resolution of the work ticket by an agent;
training, by the work ticket engine based on ticket performance data indicative of the assignment of the work ticket to the agent, the group mapping model; and
training, by the work ticket engine based on ticket performance data indicative of the resolution of the work ticket by an agent, the agent mapping model.

16. The medium of claim 13, the operations further comprising:
obtaining, by the work ticket engine, a ticketing model training dataset comprising a ticket assignment log comprising an indication of historical assignments of work tickets to agent groups; and
training, by the work ticket engine based on the ticketing model training dataset, the group mapping model to identify an agent group for assignment of a work ticket based on an issue description indicative of a technical issue corresponding to the work ticket.

17. The medium of claim 13, the operations further comprising:
obtaining, by the work ticket engine, a ticketing model training dataset comprising a ticket performance log comprising an indication of characteristics of historical resolution of work tickets by agents; and
training, by the work ticket engine based on the ticketing model training dataset, the agent mapping model to identify an agent for assignment of a work ticket based on an identified agent group for the work ticket.

18. The medium of claim 13, wherein determining the agent of the group for resolving the technical issue comprises:
determining, by the work ticket engine based on application of the agent group and agent data comprising a forecast of agent availability to the agent mapping model, the agent of the group for resolving the technical issue.
